(19) United States
(12) Patent Application Publication
(10) Pub. No.: US 2026/0237934 A1
(43) Pub. Date: Aug. 13, 2026

(54) Electrical Connector

(71) Applicants: Tarng Yu Enterprise co., ltd., New Taipei City (TW); Dongguan Tarng Yu Electronics Co., Ltd., Dongguan City (CN)

(72) Inventors: TSUNG-CHI CHEN, New Taipei City (TW); YING-CHUNG CHEN, New Taipei City (TW); MU-JUNG HUANG, New Taipei City (TW)

(21) Appl. No.: 19/533,183

(22) Filed: Feb. 8, 2026

(30) Foreign Application Priority Data
Feb. 10, 2025 (TW) 114201389

(51) Int. Cl. H01R 13/514

(52) U.S. Cl. CPC H01R 13/514

(57) ABSTRACT

An electrical connector comprises an insulation core and an insulation housing, the shape or size of the insulation core and the insulation housing being respectively customizable in design. Therefore, after the design of the electrical connector is completed, the insulation core and the insulation housing can still be adjusted to achieve customization of the shape or size of the electrical connector, so that the shape or size of the electrical connector meets expectations and can be applied in electronic devices to satisfy specific requirements and developments thereof.

### CROSS-REFERENCE TO RELATED APPLICATIONS

This application claims the priority of Republic of China Patent Application No. 114201389 filed on February 10, 2025, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector that is configured to be customized in shape or size.

### Descriptions of the Related Art

In recent years, electrical connectors have been widely applied to various electronic devices. However, once the design of an electrical connector is completed, it often cannot be modified in shape or size according to demand. This imposes limitations on the applications and operating environments of the electrical connector, thereby making it difficult for the electrical connector to flexibly adapt to electronic devices.

From the above, it can be seen that how to solve the problem wherein the design of an electrical connector cannot be modified in shape or size according to demand once completed is a problem urgently to be solved by those skilled in the art.

### SUMMARY OF THE INVENTION

In view of the drawbacks of the prior art mentioned above, the present application provides an electrical connector, comprising: an insulation core; an insulation housing, wherein long sides of the insulation housing comprise a first housing long side wall and a second housing long side wall, and short sides of the insulation housing comprise a first housing short side wall and a second housing short side wall disposed on opposite sides of the insulation housing; the first housing short side wall and the second housing short side wall are disposed on opposite sides of the insulation housing; and adjacent ones of the first housing long side wall, the second housing long side wall, the first housing short side wall, and the second housing short side wall are connected to form a housing inner space, and the housing inner space comprises an inner space inlet; and a stopper body comprising a connecting portion and a stopper portion, wherein the connecting portion is connected to the insulation housing and comprises a rotating structure, and the stopper portion comprises a stopper portion stopper structure, the stopper portion is rotatable via the rotating structure to reach a non-stopping position or a stopping position, wherein when the stopper portion reaches the non-stopping position, the insulation core is allowed to enter the housing inner space through the inner space inlet; and when the stopper portion reaches the stopping position, the stopper portion stopper structure is configured to provide a stop to the insulation core to prevent the insulation core from leaving the housing inner space through the inner space inlet.

Preferably, the electrical connector said above, wherein the connecting portion is connected to the first housing long side wall or the second housing long side wall.

Preferably, the electrical connector said above, wherein a long side of the insulation core comprises a core long side positioning structure, and a short side of the insulation core comprises a core short side positioning structure, wherein when the stopper portion reaches the stopping position, the core long side positioning structure and the core short side positioning structure are respectively engaged with the stopper body to provide positioning to the stopper portion.

Preferably, the electrical connector said above, wherein the short side of the insulation core comprises a core short side combination structure, wherein when the insulation core enters the housing inner space, the core short side combination structure combines with the insulation housing to prevent the insulation core from leaving the housing inner space.

Preferably, the electrical connector said above, further comprising a conductive terminal, wherein the insulation core comprises a terminal insertion space, the terminal insertion space comprises an insertion space inlet, and the conductive terminal is allowed to enter the terminal insertion space through the insertion space inlet; and when the stopper portion reaches the stopping position, the stopper portion stopper structure is further configured to provide a stop to the conductive terminal to prevent the conductive terminal from leaving the terminal insertion space through the insertion space inlet.

Preferably, the electrical connector said above, wherein the insulation core comprises a core body, a first row major core mating end, and a first row minor core mating end, wherein the core body is accommodated in the housing inner space, and the first row major core mating end and the first row minor core mating end are arranged in a row for mating.

Preferably, the electrical connector said above, wherein the insulation housing further comprises a housing wall support post, wherein the housing wall support post is respectively connected to the first housing long side wall and the second housing long side wall to provide support thereto, thereby maintaining the shape of the insulation housing.

Preferably, the electrical connector said above, wherein the housing inner space comprises a first row major inner space outlet and a first row minor inner space outlet; the first row major core mating end is configured to leave the housing inner space through the first row major inner space outlet for mating; the first row minor core mating end is configured to leave the housing inner space through the first row minor inner space outlet for mating; the housing wall support post comprises a housing wall support post major minor stopper structure, which is extended between the first row major inner space outlet and the first row minor inner space outlet and is configured to stop the core body from leaving the housing inner space through the first row major inner space outlet and the first row minor inner space outlet.

Preferably, the electrical connector said above, wherein the insulation core further comprises a second row major core mating end and a second row minor core mating end, wherein the second row major core mating end and the second row minor core mating end are arranged in a row for mating.

Preferably, the electrical connector said above, wherein the housing inner space further comprises a second row major inner space outlet and a second row minor inner space outlet, wherein the second row major core mating end is configured to leave the housing inner space through the second row major inner space outlet for mating; the second row minor core mating end is configured to leave the housing inner space through the second row minor inner space outlet for mating; the housing wall support post comprises a housing wall support post inter row stopper structure being extended between the first row major inner space outlet and the second row major inner space outlet and is configured to stop the core body from leaving the housing inner space through the first row major inner space outlet and the second row major inner space outlet.

Preferably, the electrical connector said above, wherein the housing wall support post inter row stopper structure is further configured to extend between the first row minor inner space outlet and the second row minor inner space outlet and is configured to stop the core body from leaving the housing inner space through the first row minor inner space outlet and the second row minor inner space outlet.

Preferably, the electrical connector said above, wherein the housing wall support post major minor stopper structure is further extended between the second row major inner space outlet and the second row minor inner space outlet and is configured to stop the core body from leaving the housing inner space through the second row major inner space outlet and the second row minor inner space outlet.

Preferably, the electrical connector said above, wherein the housing wall support post major minor stopper structure is extended longitudinally, and the housing wall support post inter row stopper structure is extended laterally.

Compared to the prior art, the electrical connector of the present application comprises an insulation core and an insulation housing, wherein the shape or size of the insulation core and the insulation housing can be respectively customized in design. That is, the shape or size of the insulation core and the insulation housing can be substantially different. Therefore, after the design of the electrical connector is completed, the insulation core and the insulation housing can still be adjusted to achieve customization of the shape or size of the electrical connector, so that the shape or size of the electrical connector meets expectations and can be applied in electronic devices to satisfy specific requirements and developments of the electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of the electrical connector of the present application from a first viewing angle in an embodiment.

FIG. 2 is a perspective view of the electrical connector of the present application from a second viewing angle in an embodiment.

FIG. 3 is a perspective view of the electrical connector of the present application from a first viewing angle in an embodiment.

FIG. 4 is a perspective view of the electrical connector of the present application from a second viewing angle in an embodiment.

FIG. 5 is a perspective view of the electrical connector of the present application from a first viewing angle in an embodiment.

FIG. 6 is a perspective view of the electrical connector of the present application from a second viewing angle in an embodiment.

FIG. 7 is a perspective view of the electrical connector of the present application from a third viewing angle in an embodiment.

FIG. 8 is a perspective view of the electrical connector of the present application from a fourth viewing angle in an embodiment.

FIG. 9 is a sectional view of a partial component of the electrical connector of the present application in an embodiment.

FIG. 10 is a sectional view of a partial component of the electrical connector of the present application in an embodiment.

FIG. 11 is a front view of the electrical connector of the present application in an embodiment.

FIG. 12 is a sectional view of a partial component of the electrical connector shown in FIG. 11, taken along line AA.

FIG. 13 is a sectional view of a partial component of the electrical connector shown in FIG. 11, taken along line BB.

FIG. 14 is a side view of the electrical connector of the present application in an embodiment.

FIG. 15 is a sectional view of a partial component of the electrical connector shown in FIG. 14, taken along line CC.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The electrical connector of the present application comprises an insulation core and an insulation housing. The shape or size of the insulation core and the insulation housing can be individually customized in design. Therefore, after the design of the electrical connector is completed, the insulation core a nd the insulation housing can still be adjusted to achieve customization of the shape or size of the electrical connector, so that the shape or size of the electrical connector meets expectations and can be used in electronic devices to meet the specific needs and developments of the electronic devices.

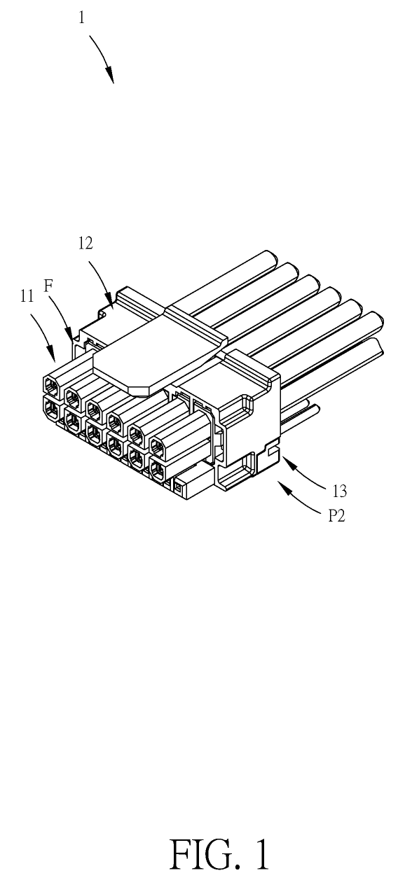

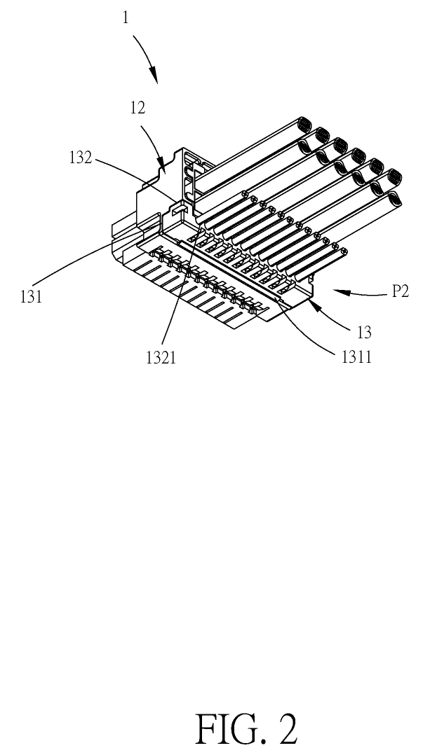

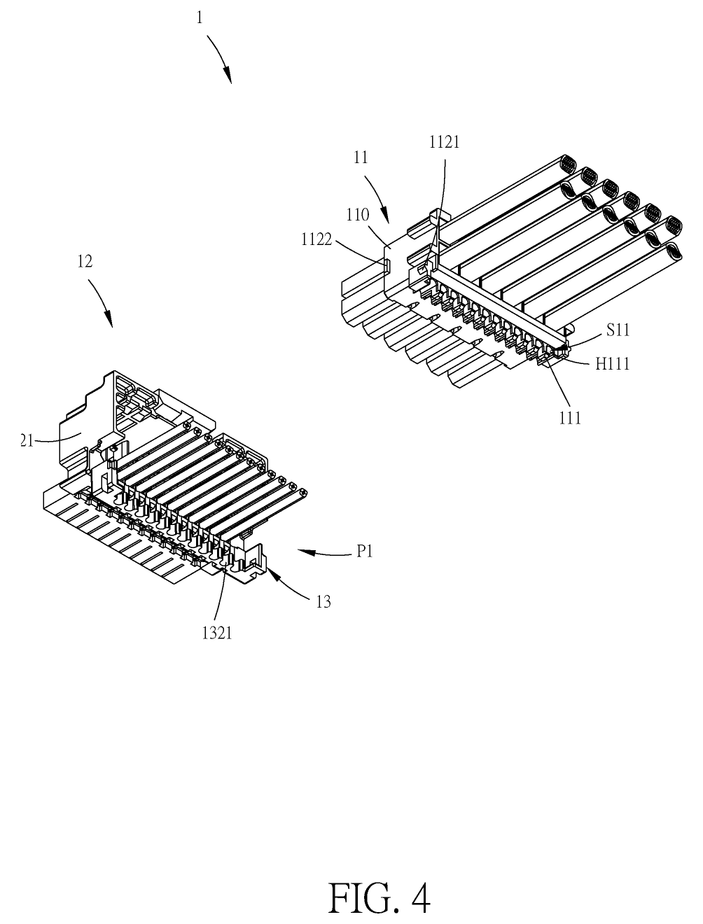

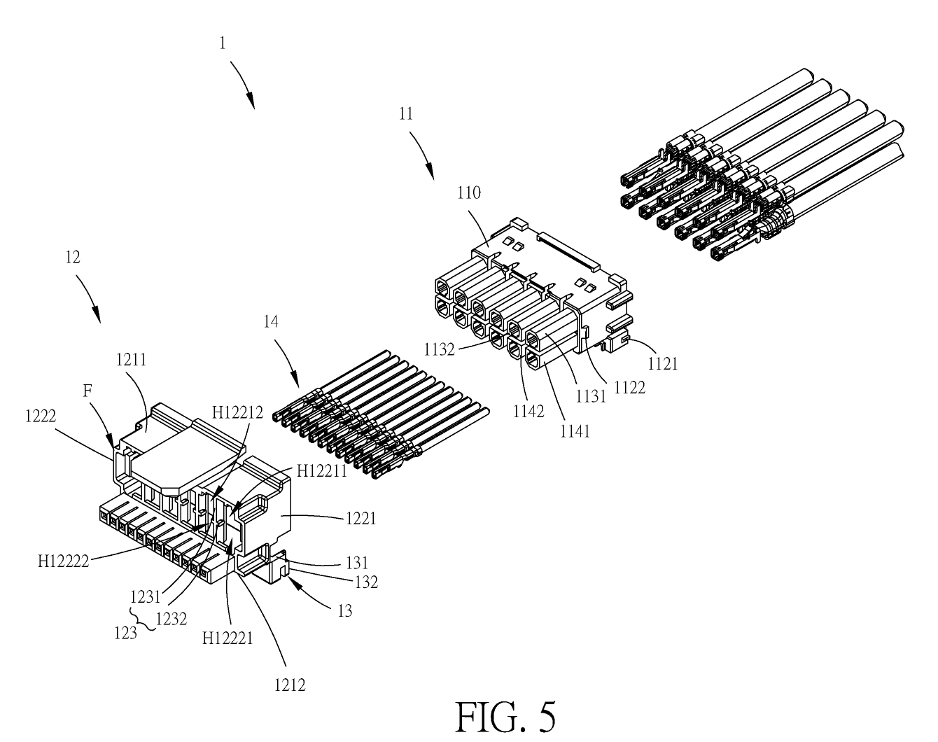

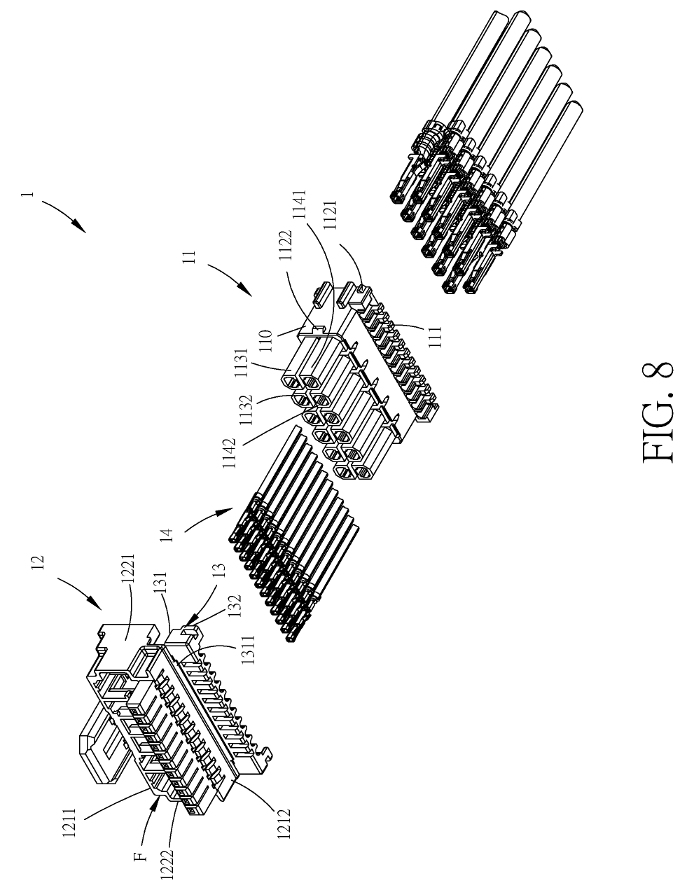

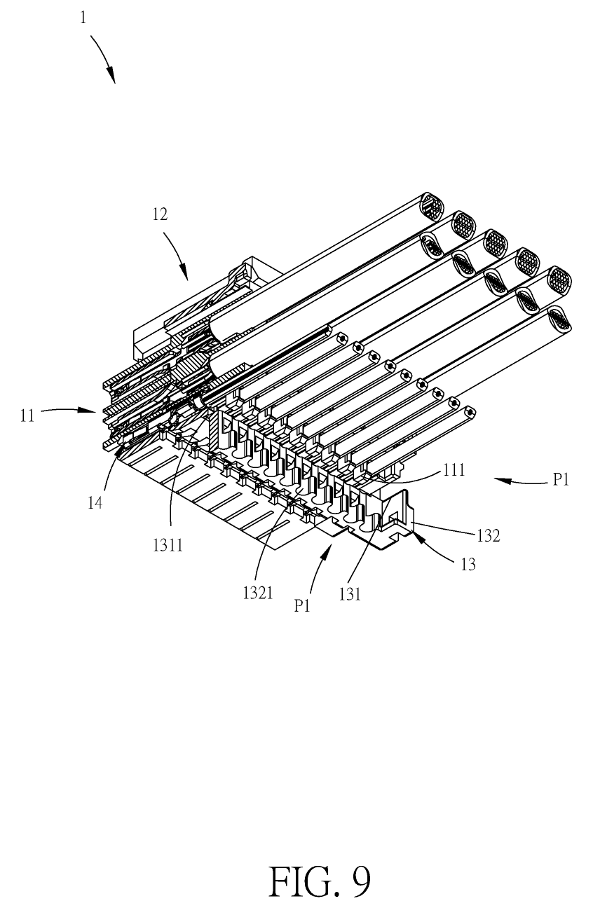

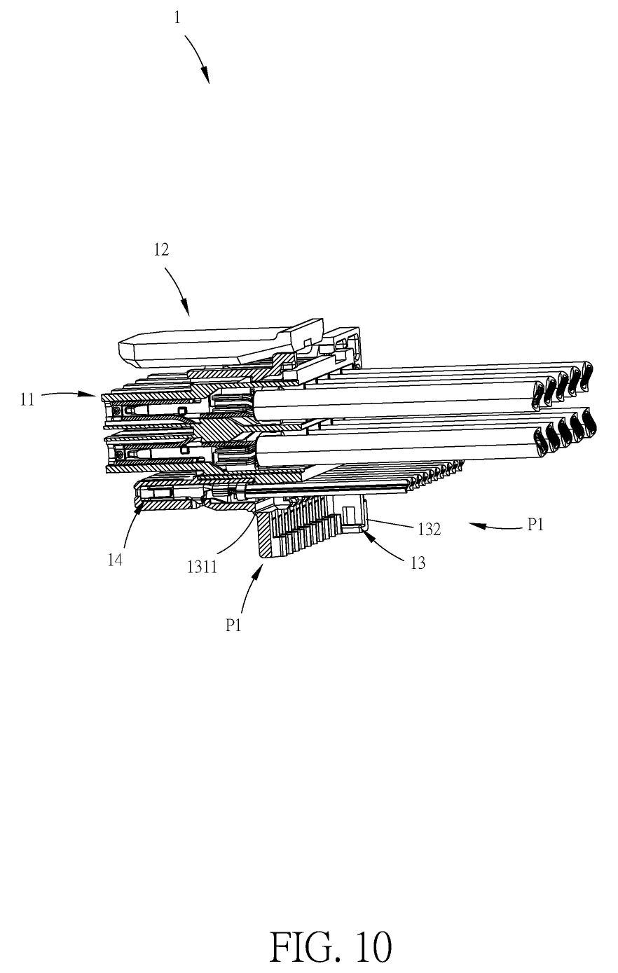

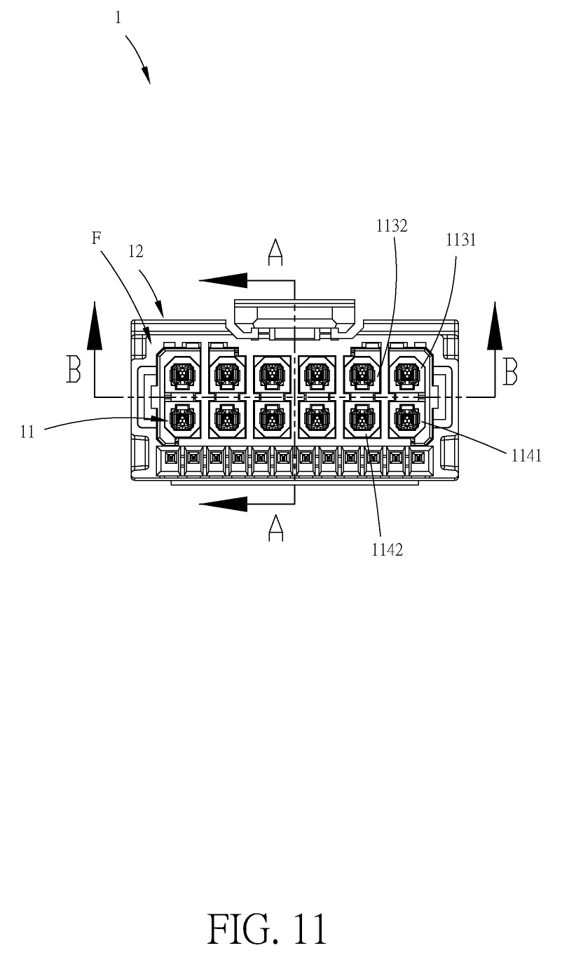

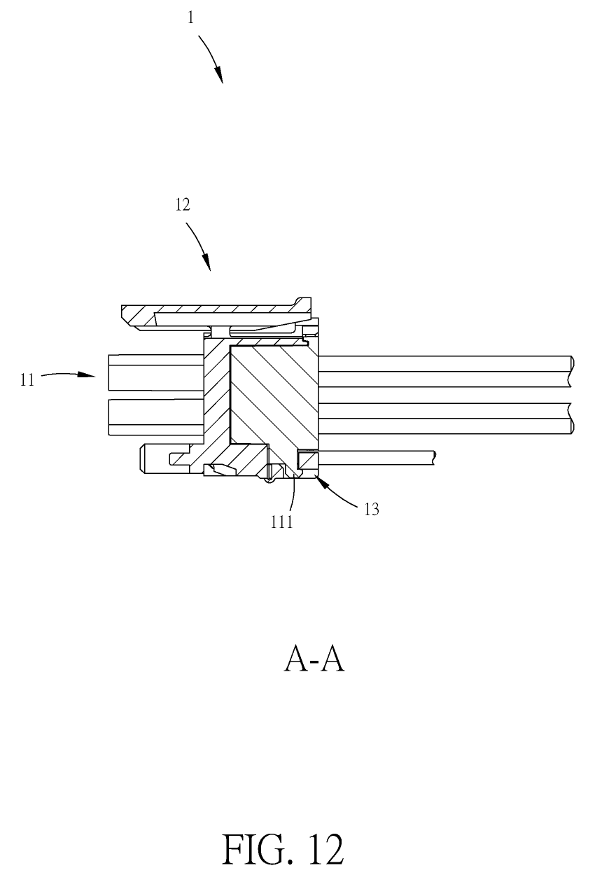

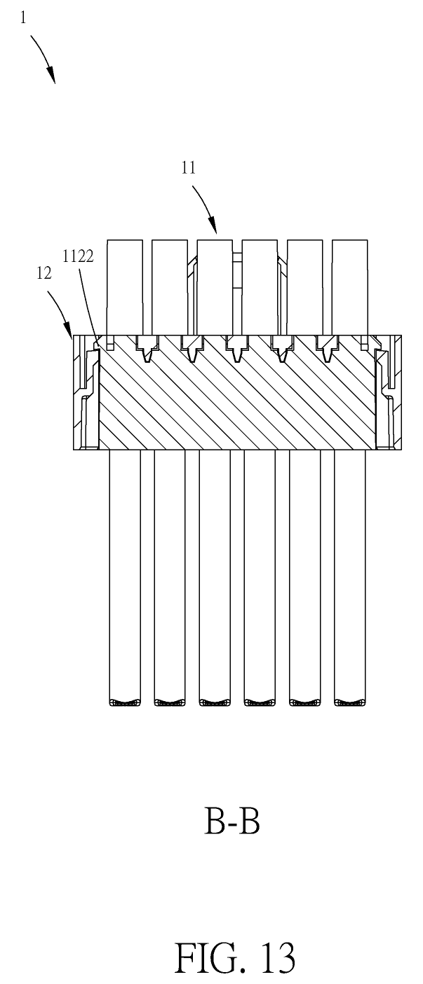

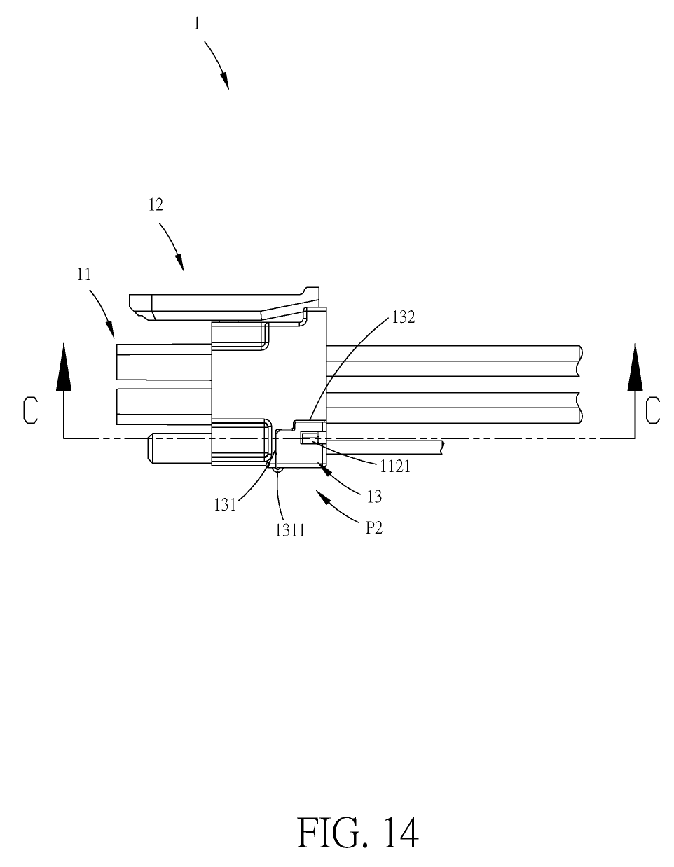

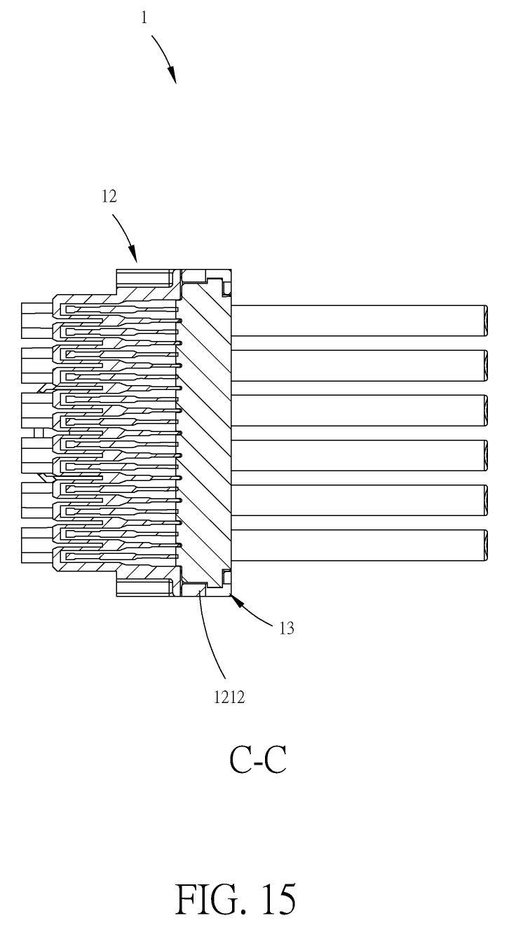

Please refer to FIGS. 1 to 15 in conjunction with the following description of the embodiments disclosed by the present application.

In the present application, an electrical connector 1 is provided for being disposed in an electronic device to transmit signals.

In the embodiments shown in FIGS. 1 to 15, the electrical connector 1 comprises: at least one insulation core 11, at least one insulation housing 12, at least one stopper body 13, and at least one conductive terminal 14.

In the above embodiments, regarding the insulation core 11, a long side of the insulation core 11 comprises at least one core long side positioning structure 111, and a short side of the insulation core 11 comprises at least one core short side positioning structure 1121. The insulation core 11 comprises at least one terminal insertion space S11, and the terminal insertion space S11 comprises at least one insertion space inlet H111, wherein the conductive terminal 14 is allowed to enter the terminal insertion space S11 through the insertion space inlet H111 to transmit signals.

It should be noted that the core long side positioning structure 111 and the core short side positioning structure 1121 may be, but are not limited to, positioning structures that can be locked with the stopper portion 132.

In the above embodiments, regarding the insulation housing 12, a long side of the insulation housing 12 comprises a first housing long side wall 1211 and a second housing long side wall 1212, and a short side of the insulation housing 12 comprises a first housing short side wall 1221 and a second housing short side wall 1222.

It should be noted that the first housing long side wall 1211 and the second housing long side wall 1212 are disposed on opposite sides of the insulation housing 12; the first housing short side wall 1221 and the second housing short side wall 1222 are disposed on opposite sides of the insulation housing 12; and adjacent ones of the first housing long side wall 1211, the second housing long side wall 1212, the first housing short side wall 1221, and the second housing short side wall 1222 are connected to form a housing frame structure F. In the above embodiments, an inner space S12 is formed inside the housing frame structure F, and the housing inner space S12 comprises an inner space inlet H121, wherein the inner space inlet H121 is located at a rear portion of the insulation housing 12.

In addition, the insulation housing 12 further comprises a housing wall support post 123, and the housing wall support post 123 is respectively connected to the first housing long side wall 1211 and the second housing long side wall 1212 to provide support thereto, thereby reinforcing the structural strength of the first housing long side wall 1211 and the second housing long side wall 1212, and maintaining the shape of the insulation housing 12, so that the size of the housing inner space S12 meets expectations.

In the above embodiments, regarding the stopper body 13, the stopper body 13 comprises a connecting portion 131 and a stopper portion 132, wherein the connecting portion 131 is connected to the insulation housing 12 and comprises a rotating structure 1311, and the stopper portion 132 comprises a stopper portion stopper structure 1321. The stopper portion 132 is rotatable via the rotating structure 1311 to reach a non-stopping position P1 or a stopping position P2.

It should be noted that when the stopper portion 132 reaches the non-stopping position P1, the insulation core 11 is allowed to enter the housing inner space S12 through the inner space inlet H121; and when the stopper portion 132 reaches the stopping position P2, the core long side positioning structure 111 and the core short side positioning structure 1121 are engaged with the stopper body 13 to provide positioning to the stopper portion 132. At this time, the stopper portion stopper structure 1321 is configured to provide a stop to the insulation core 11 to prevent the insulation core 11 from leaving the housing inner space S12 through the inner space inlet H121.

In the above embodiments, when the stopper portion 132 reaches the stopping position P2, the stopper portion stopper structure 1321 is further configured to provide a stop to the conductive terminal 14 at a rear portion of the insulation housing 12 to prevent the conductive terminal 14 from leaving the terminal insertion space S11 through the insertion space inlet H111, thereby improving the yield of the electrical connector 1.

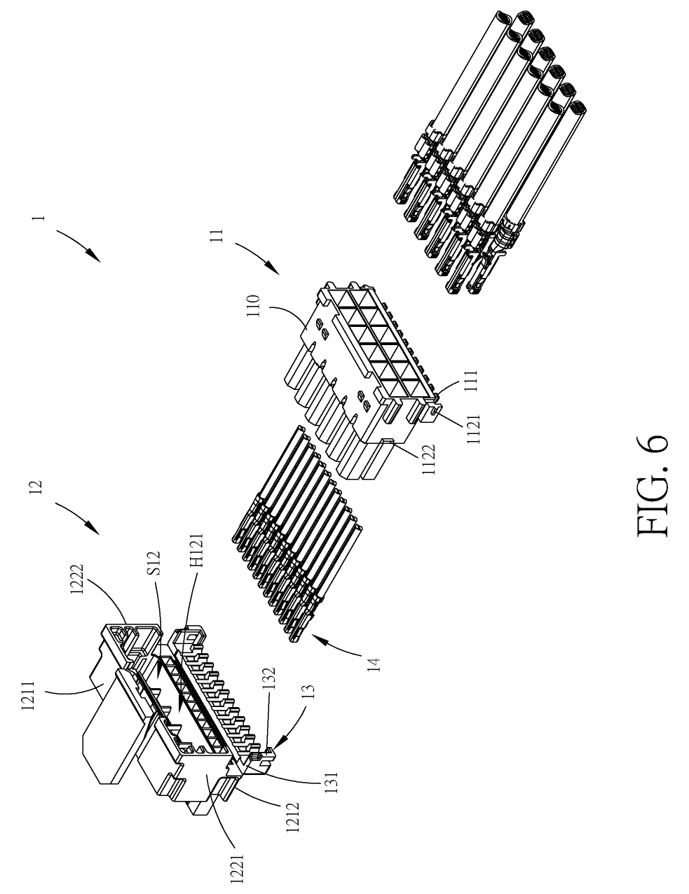

In the embodiments shown in FIGS. 6 to 8, the connecting portion 131 is connected to the first housing long side wall 1211 or the second housing long side wall 1212 to ensure that the length of the connecting portion 131 connected to the insulation housing 12 is sufficient, thereby preventing the connection between the connecting portion 131 and the insulation housing 12 from being easily damaged.

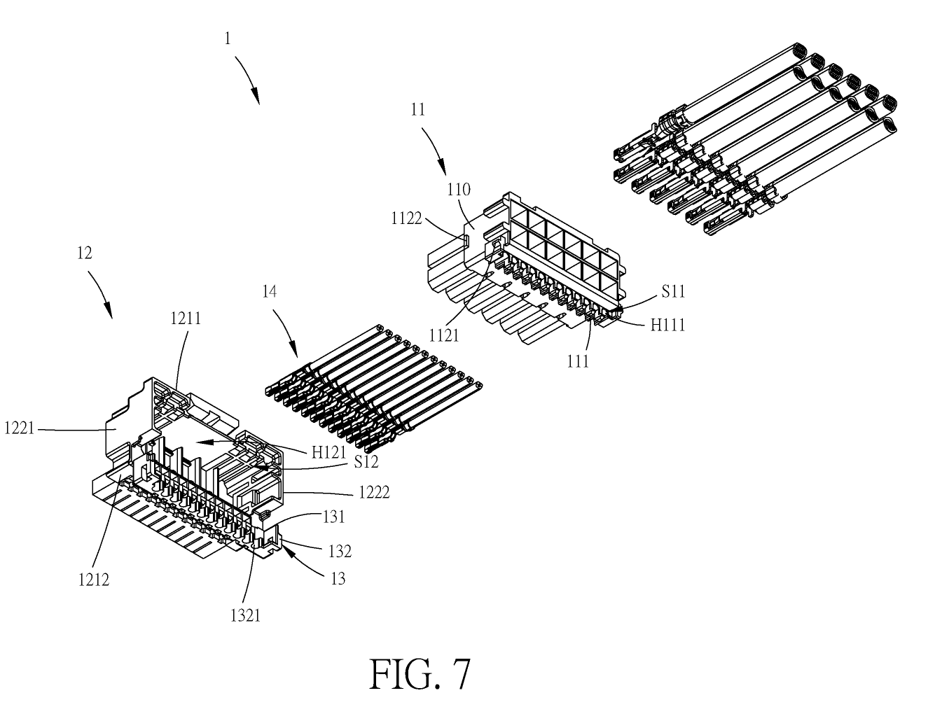

In the embodiments shown in FIGS. 6 to 7, a short side of the insulation core 11 comprises a core short side combination structure 1122. When the insulation core 11 enters the housing inner space S12, the core short side combination structure 1122 combines with the insulation housing 12 to prevent the insulation core 11 from leaving the housing inner space S12.

It should be noted that the core short side combination structure 1122 may be, but is not limited to, a combination structure that can be locked with the insulation housing 12.

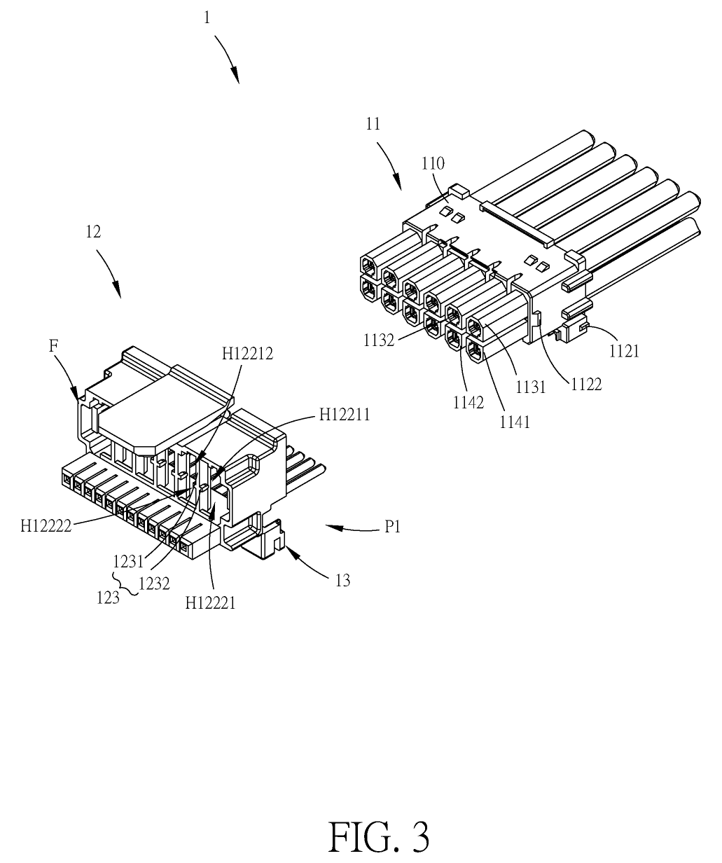

In the embodiments shown in FIGS. 3, 5, 8, and 11, the insulation core 11 comprises a core body 110, a first-row major core mating end 1131, a first-row minor core mating end 1132, a second-row major core mating end 1141, and a second-row minor core mating end 1142. The core body 110 is accommodated in the housing inner space S12. The first-row major core mating end 1131 and the first-row minor core mating end 1132 are arranged in a row for mating, and the second-row major core mating end 1141 and the second-row minor core mating end 1142 are arranged in another row for mating.

In addition, the housing inner space S12 comprises a first row major inner space outlet H12211, a first row minor inner space outlet H12212, a second row major inner space outlet H12221, and a second row minor inner space outlet H12222, wherein the first row major inner space outlet H12211, the first row minor inner space outlet H12212, the second row major inner space outlet H12221, and the second row minor inner space outlet H12222 are located at a front portion of the insulation housing 12.

It should be noted that the first-row major core mating end 1131 corresponds to the first-row major inner space outlet H12211, such that the first-row major core mating end 1131 is configured to leave the housing inner space S12 through the first-row major inner space outlet H12211 for mating. The first-row minor core mating end 1132 corresponds to the first-row minor inner space outlet H12212, such that the first-row minor core mating end 1132 is configured to leave the housing inner space S12 through the first-row minor inner space outlet H12212 for mating. The second-row major core mating end 1141 corresponds to the second-row major inner space outlet H12221, such that the second-row major core mating end 1141 is configured to leave the housing inner space S12 through the second-row major inner space outlet H12221 for mating. The second-row minor core mating end 1142 corresponds to the second-row minor inner space outlet H12222, such that the second-row minor core mating end 1142 is configured to leave the housing inner space S12 through the second-row minor inner space outlet H12222 for mating.

In the above embodiments, the housing wall support post 123 is located at a front portion of the insulation housing 12 and comprises a housing wall support post major minor stopper structure 1231 and a housing wall support post inter row stopper structure 1232. The housing wall support post major minor stopper structure 1231 may optionally extend longitudinally to extend between the first row major inner space outlet H12211 and the first row minor inner space outlet H12212, and is configured to stop the core body 110 at the front portion of the insulation housing 12 from leaving the housing inner space S12 through the first row major inner space outlet H12211 and the first row minor inner space outlet H12212, thereby improving the yield of the electrical connector 1. In addition, the housing wall support post major minor stopper structure 1231 is further extendable between the second row major inner space outlet H12221 and the second row minor inner space outlet H12222 to stop the core body 110 at the front portion of the insulation housing 12 from leaving the housing inner space S12 through the second row major inner space outlet H12221 and the second row minor inner space outlet H12222, thereby improving the yield of the electrical connector 1.

In the above embodiments, the housing wall support post inter row stopper structure 1232 may optionally extend laterally to extend between the first row major inner space outlet H12211 and the second row major inner space outlet H12221, and is configured to stop the core body 110 at the front portion of the insulation housing 12 from leaving the housing inner space S12 through the first row major inner space outlet H12211 and the second row major inner space outlet H12221, thereby improving the yield of the electrical connector 1. In addition, the housing wall support post inter row stopper structure 1232 is further extendable between the first row minor inner space outlet H12212 and the second row minor inner space outlet H12222 to stop the core body 110 at the front portion of the insulation housing 12 from leaving the housing inner space S12 through the first row minor inner space outlet H12212 and the second row minor inner space outlet H12222, thereby improving the yield of the electrical connector 1.

It should be noted that in the embodiments of the present application, some of the above components may be omitted. For example, the electrical connector of the present application may optionally comprise: an insulation core, an insulation housing, and a stopper body. The long side of the insulation housing comprises a first housing long side wall and a second housing long side wall, and the short side of the insulation housing comprises a first housing short side wall and a second housing short side wall, wherein the first housing long side wall and the second housing long side wall are disposed on opposite sides of the insulation housing; the first housing short side wall and the second housing short side wall are disposed on opposite sides of the insulation housing. Adjacent ones of the first housing long side wall, the second housing long side wall, the first housing short side wall, and the second housing short side wall are connected to form a housing inner space, and the housing inner space comprises an inner space inlet. The stopper body comprises a connecting portion and a stopper portion, wherein the connecting portion is connected to the insulation housing and comprises a rotating structure, and the stopper portion is rotatable via the rotating structure to reach a non-stopping position or a stopping position, wherein when the stopper portion reaches the non-stopping position, the insulation core is allowed to enter the housing inner space through the inner space inlet; and when the stopper portion reaches the stopping position, the stopper portion is configured to provide a stop to the insulation core to prevent the insulation core from leaving the housing inner space through the inner space inlet.

In summary, the electrical connector of the present application comprises an insulation core and an insulation housing. The shape or size of the insulation core and the insulation housing can be individually customized in design. That is, the shape or size of the insulation core and the insulation housing can be substantially different. Therefore, after the design of the electrical connector is completed, the insulation core and the insulation housing can still be adjusted to achieve customization of the shape or size of the electrical connector, so that the shape or size of the electrical connector meets expectations and can be used in electronic devices to meet the specific needs and developments of the electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, comprising:
an insulation core;
an insulation housing, wherein long sides of the insulation housing comprise a first housing long side wall and a second housing long side wall, and short sides of the insulation housing comprise a first housing short side wall and a second housing short side wall disposed on opposite sides of the insulation housing; the first housing short side wall and the second housing short side wall are disposed on opposite sides of the insulation housing; and adjacent ones of the first housing long side wall, the second housing long side wall, the first housing short side wall, and the second housing short side wall are connected to form a housing inner space, and the housing inner space comprises an inner space inlet; and
a stopper body comprising a connecting portion and a stopper portion, wherein the connecting portion is connected to the insulation housing and comprises a rotating structure, and the stopper portion comprises a stopper portion stopper structure, the stopper portion is rotatable via the rotating structure to reach a non-stopping position or a stopping position, wherein when the stopper portion reaches the non-stopping position, the insulation core is allowed to enter the housing inner space through the inner space inlet; and when the stopper portion reaches the stopping position, the stopper portion stopper structure is configured to provide a stop to the insulation core to prevent the insulation core from leaving the housing inner space through the inner space inlet.

2. The electrical connector according to claim 1, wherein the connecting portion is connected to the first housing long side wall or the second housing long side wall.

3. The electrical connector according to claim 1, wherein a long side of the insulation core comprises a core long side positioning structure, and a short side of the insulation core comprises a core short side positioning structure, wherein when the stopper portion reaches the stopping position, the core long side positioning structure and the core short side positioning structure are respectively engaged with the stopper body to provide positioning to the stopper portion.

4. The electrical connector according to claim 1, wherein the short side of the insulation core comprises a core short side combination structure, wherein when the insulation core enters the housing inner space, the core short side combination structure combines with the insulation housing to prevent the insulation core from leaving the housing inner space.

5. The electrical connector according to claim 1, further comprising a conductive terminal, wherein the insulation core comprises a terminal insertion space, the terminal insertion space comprises an insertion space inlet, and the conductive terminal is allowed to enter the terminal insertion space through the insertion space inlet; and when the stopper portion reaches the stopping position, the stopper portion stopper structure is further configured to provide a stop to the conductive terminal to prevent the conductive terminal from leaving the terminal insertion space through the insertion space inlet.

6. The electrical connector according to claim 1, wherein the insulation core comprises a core body, a first row major core mating end, and a first row minor core mating end, wherein the core body is accommodated in the housing inner space, and the first row major core mating end and the first row minor core mating end are arranged in a row for mating.

7. The electrical connector according to claim 6, wherein the insulation housing further comprises a housing wall support post, wherein the housing wall support post is respectively connected to the first housing long side wall and the second housing long side wall to provide support thereto, thereby maintaining the shape of the insulation housing.

8. The electrical connector according to claim 7, wherein the housing inner space comprises a first row major inner space outlet and a first row minor inner space outlet; the first row major core mating end is configured to leave the housing inner space through the first row major inner space outlet for mating; the first row minor core mating end is configured to leave the housing inner space through the first row minor inner space outlet for mating; the housing wall support post comprises a housing wall support post major minor stopper structure, which is extended between the first row major inner space outlet and the first row minor inner space outlet and is configured to stop the core body from leaving the housing inner space through the first row major inner space outlet and the first row minor inner space outlet.

9. The electrical connector according to claim 8, wherein the insulation core further comprises a second row major core mating end and a second row minor core mating end, wherein the second row major core mating end and the second row minor core mating end are arranged in a row for mating.

10. The electrical connector according to claim 9, wherein the housing inner space further comprises a second row major inner space outlet and a second row minor inner space outlet, wherein the second row major core mating end is configured to leave the housing inner space through the second row major inner space outlet for mating; the second row minor core mating end is configured to leave the housing inner space through the second row minor inner space outlet for mating; the housing wall support post comprises a housing wall support post inter row stopper structure being extended between the first row major inner space outlet and the second row major inner space outlet and is configured to stop the core body from leaving the housing inner space through the first row major inner space outlet and the second row major inner space outlet.

11. The electrical connector according to claim 10, wherein the housing wall support post inter row stopper structure is further configured to extend between the first row minor inner space outlet and the second row minor inner space outlet and is configured to stop the core body from leaving the housing inner space through the first row minor inner space outlet and the second row minor inner space outlet.

12. The electrical connector according to claim 10, wherein the housing wall support post major minor stopper structure is further extended between the second row major inner space outlet and the second row minor inner space outlet and is configured to stop the core body from leaving the housing inner space through the second row major inner space outlet and the second row minor inner space outlet.

13. The electrical connector according to claim 10, wherein the housing wall support post major minor stopper structure is extended longitudinally, and the housing wall support post inter row stopper structure is extended laterally.
